(19) United States
(12) Patent Application Publication
(10) Pub. No.: US 2025/0333032 A1
(43) Pub. Date: Oct. 30, 2025

(54) FOOT ASSEMBLY FOR VEHICLE WITH GROUND ENGAGING SUPPORT MEMBER

(71) Applicant: Oshkosh Corporation, Oshkosh, WI (US)

(72) Inventors: Bradley Kresge, Oshkosh, WI (US); Michael Hood, Oshkosh, WI (US); Sanjeev Kuriakose, Oshkosh, WI (US)

(73) Assignee: Oshkosh Corporation, Oshkosh, WI (US)

(21) Appl. No.: 19/190,503

(22) Filed: Apr. 25, 2025

Related U.S. Application Data
(60) Provisional application No. 63/638,496, filed on Apr. 25, 2024.

(51) Int. Cl. B60S 9/12; B60P 3/12

(52) U.S. Cl. CPC B60S 9/12; B60P 3/12; B60Y 2200/1422

(57) ABSTRACT

A vehicle includes a frame, an implement, and an outrigger. The implement is coupled with the frame. The implement is configured to be operated to move or lift another vehicle. The outrigger assembly is fixedly coupled with the vehicle. The outrigger assembly includes a member and a foot assembly. The foot assembly is coupled with an end of the member. The member is repositionable to drive the foot assembly into contact with a ground surface. The foot assembly includes a first plate and a second plate defining multiple edges configured to engage the ground surface. The first plate and the second plate are rotatably repositionable in unison about a first axis between multiple positions. The second plate is, relative to the first plate, rotatably repositionable about a second axis that is perpendicular with the first axis.

### CROSS-REFERENCE TO RELATED PATENT APPLICATION

This application claims the benefit of and priority to U.S. Provisional Application No. 63/638,496, filed Apr. 25, 2024, the entire disclosure of which is incorporated by reference herein.

### BACKGROUND

The present disclosure relates to outriggers for heavy duty vehicles. More particularly, the present disclosure relates to attachments for outriggers.

### SUMMARY

One implementation of the present disclosure is a vehicle, according to some embodiments. The vehicle includes a frame, an implement, and an outrigger. The implement is coupled with the frame. The implement is configured to be operated to move or lift another vehicle. The outrigger assembly is fixedly coupled with the vehicle. The outrigger assembly includes a member and a foot assembly. The foot assembly is coupled with an end of the member. The member is repositionable to drive the foot assembly into contact with a ground surface. The foot assembly includes a first plate and a second plate defining multiple edges configured to engage the ground surface. The first plate and the second plate are rotatably repositionable in unison about a first axis between multiple positions. The second plate is, relative to the first plate, rotatably repositionable about a second axis that is perpendicular with the first axis.

In some embodiments, the edges include a toothed pattern configured to facilitate engagement between the edges and the ground surface. In some embodiments, the second axis extends radially from the first axis.

In some embodiments, the first axis is defined by a shaft extending through an opening in an end of the member. The first plate is coupled with the shaft through a pair of flanges that define an opening through which the shaft extends. The second plate is coupled with the shaft through multiple pins that extend through openings of a pair of flanges and corresponding openings through the shaft. One of the pins defines the second axis.

In some embodiments, the second plate is repositionable between multiple different positions about the second axis. In some embodiments, the second plate is repositionable between multiple different positions about the second axis. In some embodiments, in a first of the multiple different positions about the second axis, a geometry of an inner edge of the second plate meshes with a geometry of a corresponding inner edge of the first plate.

In some embodiments, the first plate and the second plate are repositionable between multiple different positions about the first axis. In some embodiments, the outrigger assembly extends from a rear of the vehicle or a lateral side of the vehicle. In some embodiments, the second plate is translatable relative to the first plate along the first axis. The second plate is configured to be selectively locked in multiple various positions along the first axis.

Another implementation of the present disclosure is an outrigger assembly for a vehicle. The outrigger assembly includes a member and a foot assembly. The foot assembly is coupled with an end of the member. The member is repositionable to drive the foot assembly into contact with a ground surface. The foot assembly includes a first plate and a second plate defining multiple edges configured to engage the ground surface. The first plate and the second plate are rotatably repositionable in unison about a first axis between multiple positions. The second plate is, relative to the first plate, independently rotatably repositionable about a second axis that is perpendicular with the first axis.

In some embodiments, the second axis extends radially from the first axis. In some embodiments, the edges include a toothed pattern configured to facilitate engagement between the edges and the ground surface.

In some embodiments, the first axis is defined by a shaft extending through an opening in an end of the member. The first plate is coupled with the shaft through a pair of flanges that define an opening through which the shaft extends. The second plate is coupled with the shaft through multiple pins that extend through openings of a pair of flanges and corresponding openings through the shaft. One of the pins defines the second axis.

In some embodiments, the second plate is repositionable between multiple different positions about the second axis. In some embodiments, the second plate is repositionable between multiple different positions about the second axis. In a first of the different positions about the second axis, a geometry of an inner edge of the second plate meshes with a geometry of a corresponding inner edge of the first plate.

In some embodiments, the first plate and the second plate are repositionable between a multiple different positions about the first axis. In some embodiments, the second plate is translatable relative to the first plate along the first axis. The second plate is configured to be selectively locked in multiple various positions along the first axis.

Another implementation of the present disclosure is a foot assembly for an outrigger of a vehicle, according to some embodiments. The foot assembly includes a shaft, and a first plate and a second plate. The first plate and the second plate define multiple edges that are configured to engage a ground surface. The first plate is coupled with the shaft through a pair of flanges that defines an opening through which the shaft extends. The second plate is coupled with the shaft through multiple pins that extend through openings of a pair of flanges and corresponding openings through the shaft. One of the pins define a second axis. The first plate and the second plate are rotatably repositionable in unison about a first axis between multiple positions. The second plate is, relative to the first plate, rotatably repositionable about the second axis that is perpendicular with the first axis.

In some embodiments, the second plate is repositionable between multiple different positions about the second axis. In a first of the multiple different positions about the second axis, a geometry of an inner edge of the second plate meshes with a geometry of a corresponding inner edge of the first plate.

In some embodiments, the second plate is translatable relative to the first plate along the first axis by movement of the shaft. The second plate is configured to be selectively locked in multiple various positions along the first axis.

The invention is capable of other embodiments and of being carried out in various ways. Alternative exemplary embodiments relate to other features and combinations of features as may be recited herein.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a rear perspective view of a wrecker vehicle, according to some embodiments.

FIG. 2 is a side view of a rotator vehicle, according to some embodiments.

FIG. 3 is a perspective view of a rear outrigger assembly of the wrecker vehicle of FIG. 1, according to some embodiments.

FIG. 4 is a perspective view of a side outrigger assembly of the rotator vehicle of FIG. 2, according to some embodiments.

FIG. 5 is a perspective view of a foot assembly of the rear outrigger of FIG. 3 or the side outrigger assembly of FIG. 4, according to some embodiments.

FIG. 6 is a perspective view of another foot assembly in a first configuration, the foot assembly configured to be used on the rear outrigger of FIG. 3 or the side outrigger of FIG. 4, according to some embodiments.

FIG. 7 is a perspective view of the foot assembly of FIG. 6 in a second configuration, rotated about a first axis, according to some embodiments.

FIG. 8 is a perspective view of the foot assembly of FIG. 6 in a third configuration, with a portion rotated about a second axis different than the first axis, according to some embodiments.

FIG. 9 is a side view of the foot assembly of FIG. 6 in a first position about the first axis, according to some embodiments.

FIG. 10 is another side view of the foot assembly of FIG. 6 in a second position about the first axis, according to some embodiments.

FIG. 11 is a side view of the foot assembly of FIG. 6 with the portion in a first position about the second axis, according to some embodiments.

FIG. 12 is a side view of the foot assembly of FIG. 6 with the portion in a second position about the second axis, according to some embodiments.

FIG. 13 is a diagram of the foot assembly of FIG. 5 or FIG. 6 being driven into engagement with a ground surface, according to some embodiments.

FIG. 14 is a diagram of the foot assembly of FIG. 5 or FIG. 6 driven into engagement with, and compacting, the ground surface, according to some embodiments.

FIG. 15 is a rear perspective view of the feet assembly of FIG. 5 on rear outriggers of the vehicle of FIG. 1 or FIG. 2, according to some embodiments.

FIG. 16 is a top view of the feet assemblies and the vehicle of FIG. 15, according to some embodiments.

FIG. 17 is another top view of the feet assemblies and the vehicle of FIG. 15, according to some embodiments.

FIG. 18 is a rear perspective view of the feet assembles and the vehicle of FIG. 15, according to some embodiments.

FIG. 19 is a rear view of the feet assemblies and the vehicle of FIG. 15, according to some embodiments.

FIG. 20 is another rear view of the feet assemblies and the vehicle of FIG. 15, according to some embodiments.

FIG. 21 is a side view of the feet assemblies and the vehicle of FIG. 15 in a first position, according to some embodiments.

FIG. 22 is another side view of the feet assemblies and the vehicle of FIG. 15 in a second position, according to some embodiments.

FIG. 23 is an opposing side view of the feet assemblies and the vehicle of FIG. 21, according to some embodiments.

FIG. 24 is an opposing side view of the feet assemblies and the vehicle of FIG. 22, according to some embodiments.

FIG. 25 is a perspective view of the feet assemblies of FIGS. 6-12 disposed on outriggers in positions in which outboard feet face a same direction, according to some embodiments.

FIG. 26 is a perspective view of the foot assembly of FIGS. 6-12 including an extended shaft such that an outboard foot can be moved laterally, according to some embodiments.

FIG. 27 is another perspective view of the vehicle of FIG. 2, according to some embodiments.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring generally to the FIGURES, a foot assembly for an outrigger includes a shaft, a first foot, and a second foot. The first foot includes a first plate and a pair of coupling plates that extend perpendicularly from the first plate. The pair of coupling plates receive the shaft through corresponding openings. The shaft is also received within an end portion of the outrigger to couple the foot assembly with the outrigger. The second foot similarly includes a second plate and a pair of coupling plates that extend on either side of the shaft. The second foot is positioned next to the first foot. The first foot and the second foot are selectively repositionable and lockable between different positions about a first axis that extends longitudinally through the shaft. The second foot is independently repositionable and lockable between different positions about a second axis that extends perpendicularly to the first axis. Advantageously, the foot assembly facilitates adjusting an angle of engagement between different portions of the foot assembly in multiple different directions.

The foot assembly advantageously facilitates compaction of the ground surface into which the foot assembly is driven. In particular, a support surface of the foot assembly may face away from the vehicle at an angle which facilitates improved compaction of the ground surface. Other outrigger systems include surfaces that are inserted substantially perpendicularly to the ground surface do not compact the soil or ground as the surfaces are inserted, which, when the vehicle is exposed to loads (e.g., while lifting or moving a disabled vehicle), cause the outrigger to dig up uncompressed dirt, which reduces stability of the vehicle.

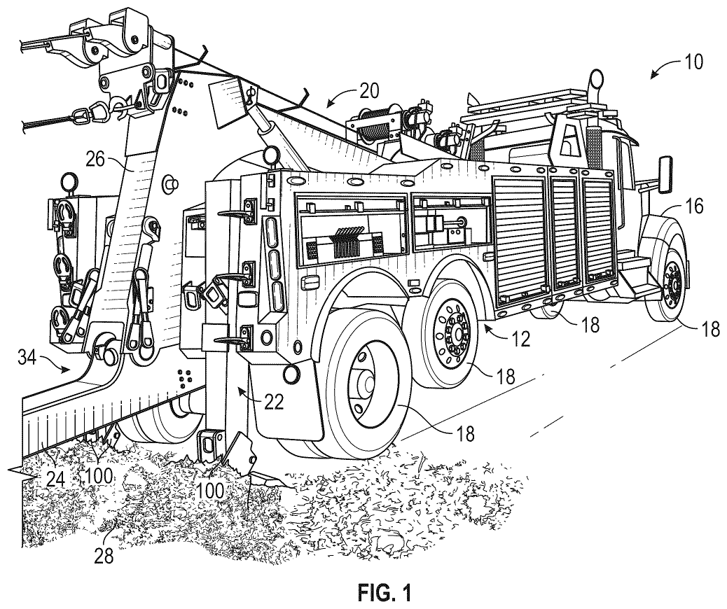

Referring particularly to FIG. 1, a wrecker vehicle 10 (e.g., a tow truck) includes a frame 12 (e.g., a chassis), a body 14, a cab 16, and tractive elements 18, according to an exemplary embodiment. The frame 12 supports both the body 14 and the cab 16. The cab 16 is configured to define an area for an operator to drive and operate the wrecker vehicle 10. The cab 16 is positioned at a front of the wrecker vehicle 10. The frame 12 may also support a driveline including an engine or electric motor, a transmission, one or more axles, etc. The transmission and axles are configured to transfer torque from the engine or electric motors to the tractive elements 18 to transport the wrecker vehicle 10.

The wrecker vehicle 10 also includes a recovery boom assembly 20 (e.g., an implement) positioned on top of the wrecker vehicle 10. The recovery boom assembly 20 may include an extendable section having cables and a winch configured to raise and lower a vehicle to be recovered and towed. The recovery boom assembly 20 may be pivotally coupled at a position along the wrecker vehicle 10 proximate the cabin 16. The recovery boom assembly 20 is configured to be drive to pivot at the position by extension or retraction of one or more cylinders (e.g., hydraulic cylinders). The extendable section may be a telescoping member that extends and retracts from an outer member within which the extendable section is received. The wrecker vehicle 10 also includes an under lift assembly 34 (e.g., an implement). The under lift assembly 34 may be coupled with the recovery boom assembly 20 through a member 26 such that the under lift assembly 34 is rotated (e.g., raised and lowered) as the recovery boom assembly 20 is driven to pivot. The under lift assembly 34 may include an extendable section 24 that is configured to be driven to extend or retract to recover a vehicle. The under lift assembly 34 and the recovery boom assembly 20 are configured to protrude from a rear of the wrecker vehicle 10 (e.g., an end of the vehicle 10 opposite the cabin 16).

The wrecker vehicle 10 also includes multiple outrigger assemblies 22 (e.g., ground-engaging support members) positioned on the rear of the wrecker vehicle 10. The outrigger assemblies 22 may be telescoping members that are fixed to the rear of the wrecker vehicle 10. The outrigger assemblies 22 may be driven to extend by an actuator (e.g., a hydraulic cylinder) so that an end of the outrigger assemblies 22 including a foot assembly 100 is driven into engagement with a ground surface 28. The feet assemblies 100 of the outrigger assemblies 22 are configured to engage or dig into the ground surface 28 such that, when the wrecker vehicle 10 is recovering a disabled vehicle, the feet assemblies 100 provide a counter-force or reactionary force to improve stability of the wrecker vehicle 10 (e.g., to provide a counter-moment in a direction opposite a rotational moment applied to the wrecker vehicle 10 due to recovery and towing operations of a disabled vehicle). One or more surfaces of the feet assemblies 100 (e.g., first plate 110 and the second plate 112) that engage the ground surface 28 may be oriented perpendicularly to the resultant force required to resist loading and reduce ground pressure (e.g., to thereby prevent the feet assemblies 100 from sinking into the ground).

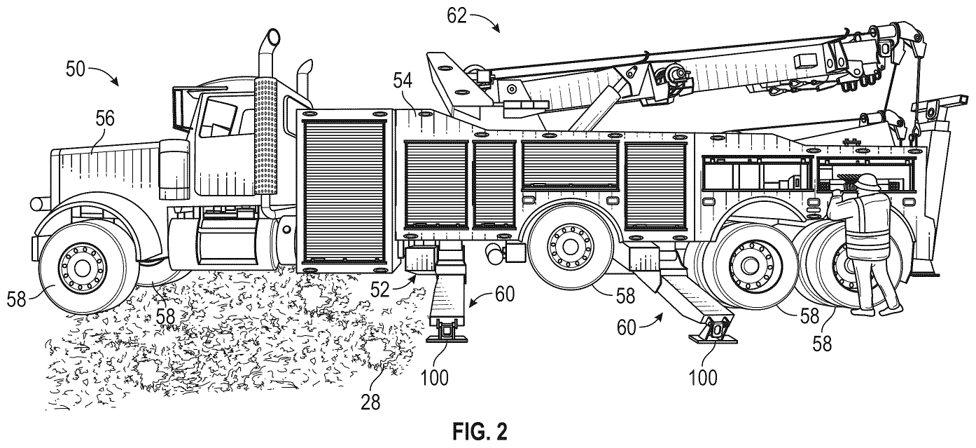

Referring to FIG. 2, a rotator vehicle 50 that is also configured to recover disabled vehicles from multiple directions (e.g., on a side of the rotator vehicle 50, at an angle from the rotator vehicle 50, etc.) includes a frame 52 (e.g., a chassis), a body 54, and a cab 56. The frame 52 may be similar to the frame 12 of the wrecker vehicle 10. The rotator vehicle 50 may include outrigger assemblies 60 (e.g., ground-engaging support members) that are coupled with the frame 12 and extend laterally outwards from a lateral side of the rotator vehicle 50. The rotator vehicle 50 includes a rotator boom assembly 62 (e.g., an implement). The rotator boom assembly 62 includes one or more extendable sections that can be driven to extend or retract in order to reach a disabled vehicle. The rotator boom assembly 62 is rotatably coupled with the frame 52 (e.g., through a turntable) and is configured to rotate relative to the rotator vehicle 50 such that the rotator boom assembly 62 can retrieve and lift disabled vehicles or trucks, lift the disable vehicle, and move the disabled vehicle (e.g., out of a ditch, to a location where the disabled vehicle can be towed, etc.).

The outrigger assemblies 60 may be coupled with an extension mechanism or apparatus on an underside of the rotator vehicle 50. The outrigger assemblies 60 may be deployed manually or automatically by being extended laterally outwards from the rotator vehicle 50. Once the outrigger assemblies 60 are extended laterally outwards, the extension apparatus can be operated to drive the outrigger assemblies 60 and the foot assemblies 100 that are coupled with the ends of the outrigger assemblies 60 into the ground surface 28. The extension apparatus may be extended until the foot assemblies 100 contact the ground surface 28 or until the tractive elements 58 are lifted off the ground.

It should be understood that the vehicle 10 or the vehicle 50 may be any other type of recovery vehicle (e.g., a bobcat or skid steer, a bull dozer, forestry vehicles, a crane, etc.). The feet assemblies 100 may be provided on any vehicle that requires improved stability responsive to loading relative to a ground surface.

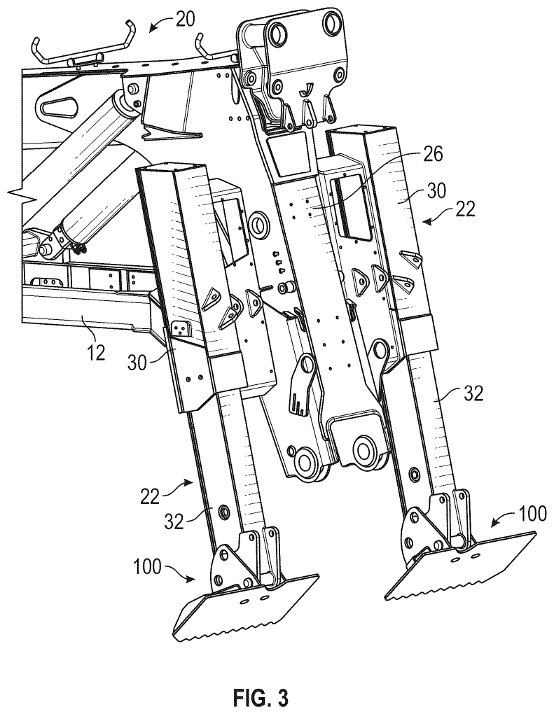

Referring to FIG. 3, the outrigger assemblies 22 of the wrecker vehicle 10 include an outer member 30 that is fixedly coupled with the frame 12. The outer member 30 is configured to receive an inner member 32 (e.g., an extendable member) that can be driven to extend or retract relative to the outer member 30 (e.g., into and out of the outer member 30). The foot assemblies 100 are coupled with an end of the inner members 32 opposite the ends of the inner member 32 that are received within the outer members 30. The foot assemblies 100 may be repositionable between different angular positions such that portions of the foot assemblies 100 are angled relative to the ground surface 28 in order to improve engagement between the foot assemblies 100 and the ground surface 28.

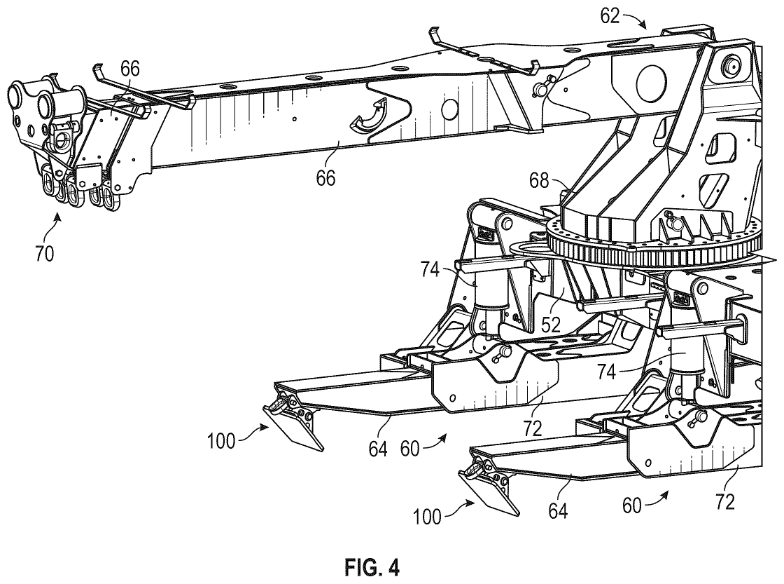

Referring to FIG. 4, the rotator boom assembly 62 includes one or more telescoping boom sections 66 pivotally coupled at a first end with a turntable 68. An end of an outer of the telescoping boom sections 66 includes a winch assembly 70 that is configured to raise or lower a grasping member (e.g., a claw, a hook, etc.) via cables to raise or lower a disabled vehicle. The turntable 68 is coupled with the frame 52 such that the turntable 68 and the boom sections 66 can be rotated about a vertical axis relative to the frame 52.

Referring still to FIG. 4, the outrigger assemblies 60 are coupled with the frame 52 through actuators 74. The actuator 74 are configured to extend to move the outrigger assemblies 60 in a downwards direction (e.g., away from the underside of the rotator vehicle 50 and towards the ground surface 28), or retract to move the outrigger assemblies in an upwards direction (e.g., towards the underside of the rotator vehicle 50 and away from the ground surface 28).

The outrigger assemblies 60 include telescoping or extendable sections oriented in a lateral direction, shown as outer member 72 and inner members 64 (e.g., extendable members). The outer members 72 are coupled with the frame 52 and allowed to move upwards or downwards relative to the frame 52. For example, the outer members 72 may be coupled with the frame 52 through the actuators 74. The inner members 64 are received within the outer member 72 and are configured to be extended or retracted relative to the outer members 72 (e.g., either manually or automatically through operation of actuators). The inner members 64 may be manually pinned in an extended position. The inner members 64 include the foot assemblies 100 positioned at an outer end of the inner member 64. When the inner member 64 are fully extended, and locked in position, and the actuators 74 are driven to extend, the foot assemblies 100 are driven into engagement with the ground surface 28.

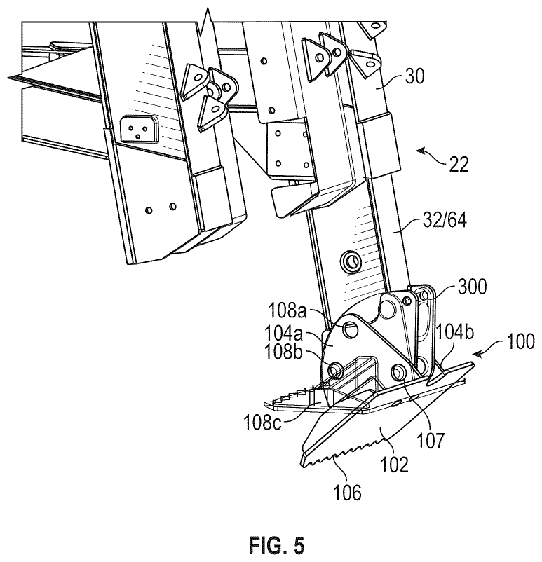

Referring to FIG. 5, the foot assembly 100 is shown in greater detail, according to a first embodiment. The foot assembly 100 includes a plate 102 and a pair of plates 104a and 104b that extend perpendicularly from the plate 102. The plate 102 may be a structural member including reinforced sections (e.g., weldments). The plates 104a and 104b form a space therebetween and may have the form of a clevis. The plates 104a and 104b are parallel with each other and may include a first opening 107 at a first radial position relative to a corner of the plates 104 that intersect the plate 102. The plates 104 also include second openings, shown as second opening 108a, second opening 108b, and second opening 108c at second radial positions relative to the corner of the plates 104, with the second radius being greater than the first radial position. The first opening 107 and the second openings 108 are each configured to receive a pin therethrough. The inner member 32 or the inner member 64 also include an interfacing portion 300 that is configured to be received within the space defined between the plates 104 when the foot assembly 100 is installed. The interfacing portion 300 include openings (e.g., bores, apertures, through-holes, etc.) including a first opening positioned such that the first opening aligns with the first opening 107 of the plates 104, and a second opening positioned such that the second opening aligns with one of the second openings 108, depending on the position of the plate 102 and the plates 104. The foot assembly 100 (e.g., the plate 102 and the plates 104) may be repositionable between multiple positions relative to the interfacing portion 300 by removing pins from one of the second openings 108, adjusting the position or orientation of the foot assembly 100 relative to a pin extending through the first opening 107 and the corresponding opening of the interfacing portion 300 until a different one of the second openings 108 aligns with the second opening of the interfacing portion 300, and reinserting the pin into the different one of the second openings 108 and through the corresponding opening of the interfacing portion 300. In this way, the foot assembly 100 is repositionable relative to the interfacing portion 300 about a first axis.

Referring still to FIG. 5, the plate 102 may include an edge 106 that is configured to engage or dig into the ground surface 28. The edge 106 may have a toothed pattern or zig-zag edge configured to facilitate engagement between the foot assembly 100 and the ground surface 28.

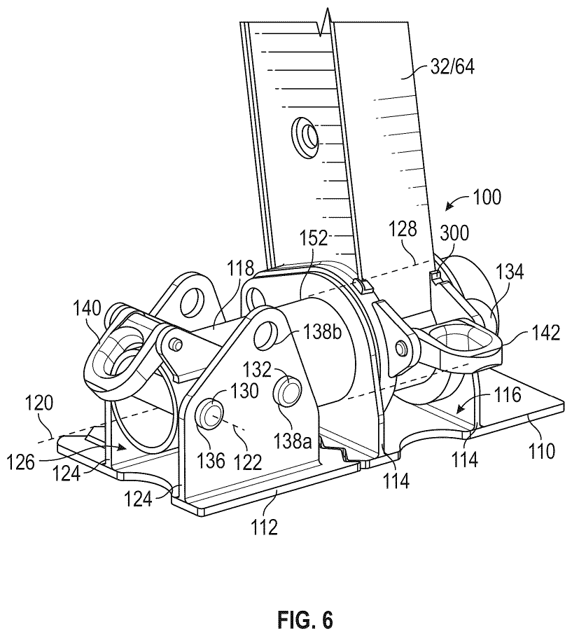

Referring to FIGS. 6-10, the foot assembly 100 is shown according to a second embodiment. The foot assembly 100 described herein with reference to FIGS. 6-10 may include multiple sections or portions that can be repositioned between multiple positions about two different axes. For example, while the foot assembly 100 described in greater detail above with reference to FIG. 5 is repositionable between multiple positions about only a first axis or direction or rotation, the foot assembly 100 described herein with reference to FIGS. 6-10 includes multiple sections or portions, both of which are repositionable about a first axis or direction, and one of which is independently repositionable about a second axis or direction. The foot assembly 100 described herein facilitates improved engagement with the ground surface 28.

Referring particularly to FIG. 6, the foot assembly 100 includes a first plate 110, a second plate 112, and a shaft 118 (e.g., a pin, a tubular member, a cylindrical member, etc.). The first plate 110 and the second plate 112 are coupled with the shaft 118 such that the first plate 110 and the second plate 112 are rotatable relative to the shaft 118. The shaft 118 defines a first axis 120 about which the first plate 110 and the second plate 112 are repositionable. The shaft 118 includes a hook 140 (e.g., an interfacing portion, a D-ring, etc.) to facilitate securing hooked end of cables or ropes and to facilitate user interaction via the foot assembly 100.

The first plate 110 includes a pair of coupling plates 114 (e.g., flanges) that extend perpendicularly from the first plate 110 and define a space 116 therebetween. The first plate 110 and the coupling plates 114 may be integrally formed or welded with each other to form a first foot portion sub-assembly or first foot component. The coupling plates 114 may form a clevis within which the interfacing portion 300 of the inner member 32 or the inner member 64 is configured to be received. The coupling plates 114 include openings 152 (e.g., a hole, an aperture, etc.) through which the shaft 118 is received. The interfacing portion 300 also includes a bore 128 (e.g., a passage, a hole, an inner volume, an opening, an aperture, etc.) through which the shaft 118 is received. The second plate 112 is repositionably coupled with the shaft 118 as described in greater detail below. The first plate 110 may be coupled with the shaft 118 through a pin 134 that extends through an opening formed in a tab of one of the coupling plates 114 and extends through a corresponding opening in the shaft 118. In particular, the pin 134 is configured to pin the first plate 110 with the shaft 118 so that the shaft 118 and the first plate 110 rotate in unison about the first axis 120. When the first plate 110 or the shaft 118 is rotated about the first axis 120 to achieve different positions about the first axis 120, the second plate 112 is also rotated about the first axis 120. The foot assembly 100 also includes a hook 142 (e.g. a D-ring) similar to the hook 140 at the interfacing portion 300 to facilitate coupling with cables or user interaction via the hook 142.

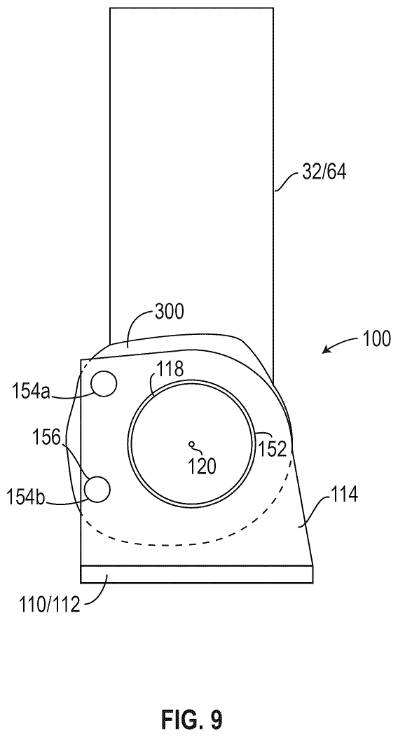

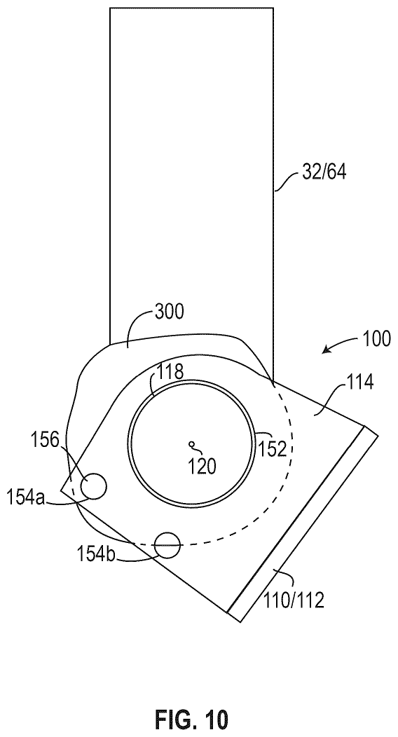

Referring particularly to FIGS. 6 and 9-10, the first plate 110 and the second plate 112, when rotated about the first axis 120, may be locked in different positions about the first axis 120. In particular, the first plate 110 may be pinned to the interfacing portion 300 when in different positions about the first axis 120. As shown in FIGS. 9 and 10, the coupling plates 114 include a first opening 154a and a second opening 154b positioned radially outwards from the first axis 120. The first opening 154a and the second opening 154b may be offset about the first axis 120 in order to define different angular positions of the first plate 110 and the second plate 112 about the first axis 120.

The interfacing portion 300 also includes an opening 156 positioned at a same radial position outwards from the first axis 120. The first plate 110 and the second plate 112 can be rotated about the first axis 120 until one of the first opening 154a or the second opening 154b are aligned with the opening 156 of the interfacing portion 300. The first plate 110 and the second plate 112 may be rotated about the first axis 120 (e.g., in unison with the shaft 118) until the second opening 154b is aligned with the opening 156 of the interfacing portion 300 to transition the first plate 110 and the second plate 112 into a first position about the first axis 120 (e.g., as shown in FIG. 9). A pin may be inserted through the openings 154b of the coupling plates 114 and the opening 156 of the interfacing portion 300 to lock the foot assembly 100 in the first position about the first axis 120. Similarly, in order to transition the foot assembly 100 into a second position about the first axis 120, the foot assembly 100 (e.g., the first plate 110 and the second plate 112) may be rotated about the first axis 120 until the first opening 154a is aligned with the opening 156 of the interfacing portion 300, and then the pin may be inserted through the first openings 154a of the coupling plates 114 and the opening 156 (e.g., a through-hole, a bore, etc.) of the interfacing portion 300. In this way, the foot assembly 100 may be repositioned between different angular positions about the first axis 120 as defined by the openings 154. It should be understood that while FIGS. 9 and 10 illustrate two openings 154, any number of openings 154 may be provided at different angular positions about the openings 152 in order to provide different positions about the axis 120 that the foot assembly 100 may be locked in. It should also be understood that, while the coupling plates 114 are described as having multiple openings 154 at different angular positions about the opening 152, the interfacing portion 300 may include multiple openings 156 disposed at different angular positions about the axis 120 in order to facilitate locking the foot assembly 100 in different angular positions about the first axis 120.

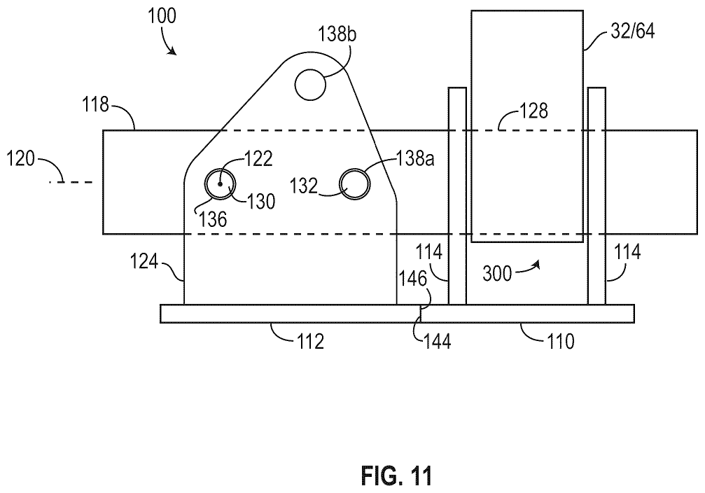

Referring to FIGS. 6 and 11, the second plate 112 is pinned onto the shaft 118 via a first pin 130 and a second pin 132. The first pin 130 is configured to be received within a first opening 136 of coupling plates 124 (e.g., flanges) that protrude perpendicularly from the second plate 112. The coupling plates 124 define a space 126 therebetween within which the shaft 118 is received. The coupling plates 124 each define the first opening 136 as well as second openings 138, shown as second opening 138a and second opening 138b. The second openings 138 define different positions of the second plate 112 about the second axis 122. The second axis 122 is perpendicular to the first axis 120. The first opening 136 and the second opening 138a can be aligned with corresponding openings that extend through the shaft 118, with the first pin 130 inserted through the first opening 136 and the second pin 132 inserted through the second opening 138a in order to lock the second plate 112 in the first position as shown in FIGS. 6 and 11. The second plate 112 and the coupling plates 124 may be integrally formed or welded with each other to form a second foot portion sub-assembly or second foot component.

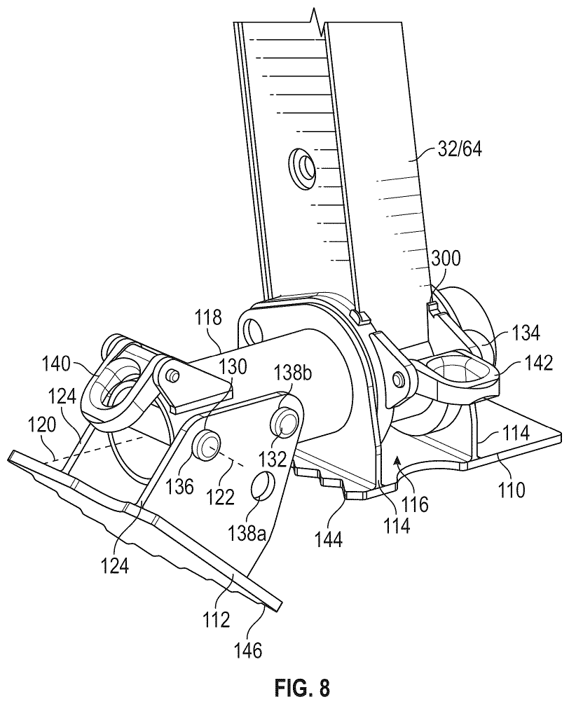

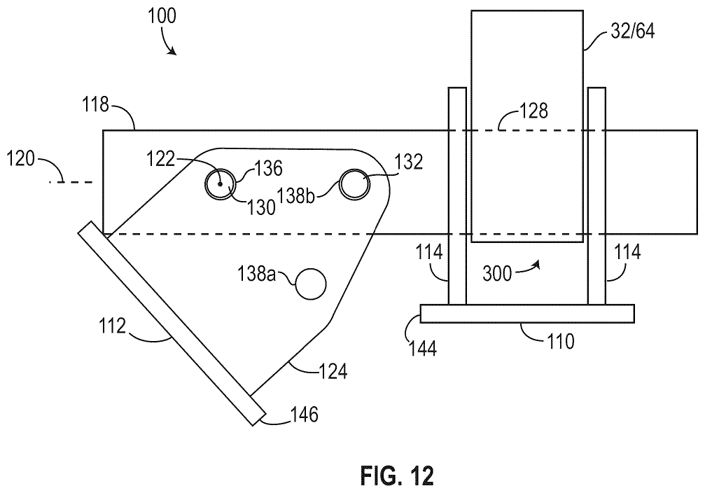

In order to transition the second plate 112 into a second position about the second axis 122 relative to the first plate 110 (regardless of what position the first plate 110 and the second plate 112 are currently locked in about the first axis 120), the first pin 130 and the second pin 132 can be removed from the first opening 136 and the second opening 138a, respectively, and the second plate 112 and coupling plates 124 re-positioned such that the first opening 136 and the second opening 138b are aligned with the openings extending through the shaft 118 as shown in FIGS. 8 and 12. Once the first opening 136 and the second opening 138b are aligned with the corresponding openings of the shaft 118, the first pin 130 may be inserted through the first openings 136 and the corresponding opening through the shaft 118, and the second pin 132 may be inserted through the second openings 138b and the corresponding opening through the shaft 118 in order to lock the second plate 112 in the second position about the second axis 122 as shown in FIGS. 8 and 12. In some embodiments, transitioning the second plate 112 out of the first position about the second axis 122 shown in FIG. 11 and into the second position about the second axis 122 shown in FIG. 12 is achieved by only requiring removal of the second pin 132, rotating the second plate 112 and coupling plates 124 until the second opening 138b is aligned with the corresponding opening through the shaft 118, and then inserting the second pin 132 through the second opening 138b and the corresponding opening of the shaft 118.

Referring to FIGS. 6 and 11, when the second plate 112 is in the first position, an inner edge 146 of the second plate 112 is proximate (e.g., contacts, abuts, engages, etc.) an inner edge 144 of the first plate 110. The inner edge 146 and the inner edge 144 may have a zig-zag, sawtooth, or other pattern such that when the second plate 112 is in the first position, the inner edge 146 and the inner edge 144 mesh with each other. More generally, the inner edge 146 and the inner edge 144 have geometry that is configured to mesh when the second plate 112 is in the first position. Referring to FIGS. 8 and 12, when the second plate 112 is in the second position, the inner edge 146 of the second plate 112 is moved away from the inner edge 144 of the first plate 110. Advantageously, transitioning the second plate 112 into the second position shown in FIG. 12 facilitates improved engagement of the inner edge 146 of the second plate 112 into the ground surface 28 in a different direction than the first plate 110 engages the ground surface 28.

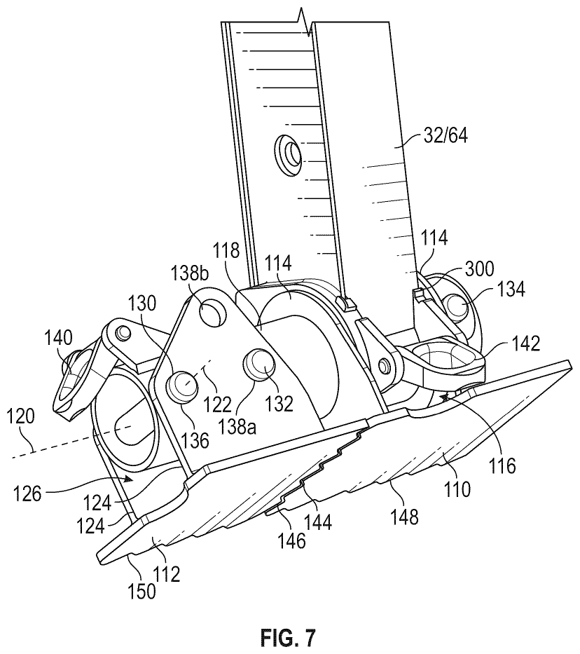

Referring particularly to FIG. 7, the first plate 110 also includes an outer edge 148. The second plate 112 also includes an outer edge 150 that is aligned with the outer edge 148 of the first plate 110 when the second plate 112 is in the first position shown in FIG. 7. The outer edge 148 and the outer edge 150 may similarly include a zig-zag, sawtooth, or other teethed shape in order to facilitate engagement with the ground surface 28. In particular, rotation of the first plate 110 (and the second plate 112 if the second plate 112 is in the first position) about the first axis 120 adjusts an orientation or angle at which the outer edge 148 (and the outer edge 150 if the second plate 112 is in the first position) engages or digs into the ground surface 28.

Referring to FIGS. 11-12, it should be understood that, while the second plate 112 is described as being repositionable between two positions about the second axis 122, the coupling plates 124 of the second plate 112 may include more than two second openings 138 in order to define more than two orientations or predetermined positions of the second plate 112 about the second axis 122.

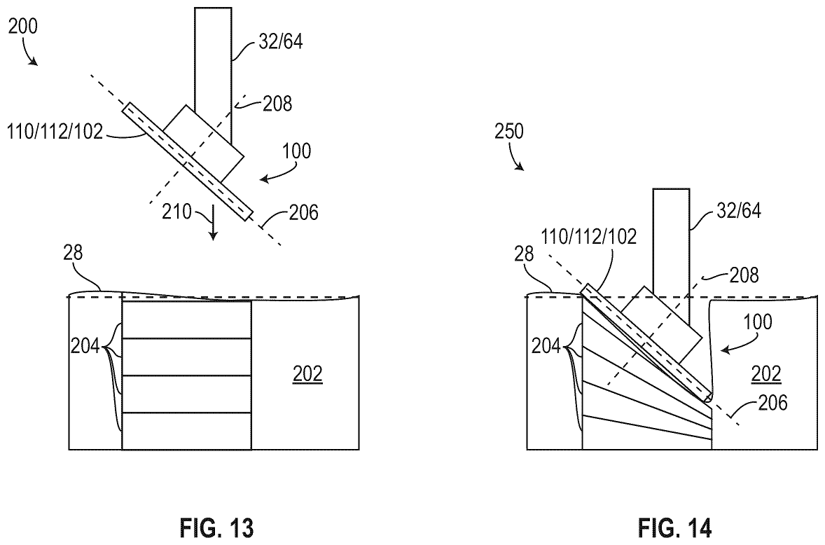

Referring to FIGS. 13 and 14, diagrams 200 and 250 illustrate insertion of the foot assembly 100 into the ground surface 28 in a direction 210. The direction 210 is substantially perpendicular to the ground surface 28. The foot assembly 100 is oriented such that a plate (e.g., the first plate 110, the second plate 112, or the plate 102) is at an angle relative to the ground surface 28. In particular, a first axis 206 that extends parallel with the plate to be driven into engagement with the ground surface 28 is non-parallel with the ground surface 28. Likewise, a second axis 208 that is perpendicular to the first axis 206 (orthogonal to the plate 110, 112, or 102) is non-parallel with the ground surface 28.

When the foot assembly 100 is driven into engagement with the ground surface 28, the foot assembly 100 may compact portions 204 of ground 202 beneath the ground surface 28. As shown in FIGS. 13 and 14, the portions 204 of the ground 202 are compacted as the foot assembly 100 is driven into engagement with the ground surface 28, which results in improved stability. Further, the foot assembly 100 may be angled relative to the ground surface 28 such that the foot assembly 100 is driven to further compact the portions 204 of the ground 202 when loaded in a transverse direction (e.g., to the left in FIG. 13). Advantageously, the foot assembly 100 is repositionable between different angular positions about at least one axis (e.g., a single axis in the embodiment described in greater detail above with reference to FIG. 5, or multiple axes as in the embodiment described in greater detail above with reference to FIGS. 6-12) in order to compact the ground and provide improved stability for the vehicle 10 or the vehicle 50. Compacted earth, soil, dirt, sand, or clay, may provide a tougher surface that is less likely to cause the ground to tear or be dug up during loading of the foot assembly 100 during vehicle retrieval operations of the vehicle 10 or the vehicle 50. Further, the foot assembly 100 may be angled such that the surface of the foot assembly that abuts the ground surface 28 at least partially faces a direction in which forces are expected to be transferred to the vehicle 10 or the vehicle 50. In the case of the vehicle 10, the plate 102, the first plate 110, or the second plate 112 may be angled such that the bottom surface (which abuts the ground surface 28) at least partially faces a rearward direction (e.g., away from a back end of the vehicle 10). Likewise, for the vehicle 50, the plate 102, the first plate 110, or the second plate 112 may be angled laterally outwards on opposite lateral sides of the vehicle 50. The foot assembly 100 as described in greater detail above with reference to FIGS. 6-12 facilitates compaction of the ground in multiple directions and can provide stabilizing contacts in multiple directions which may be experienced during retrieval of a disabled vehicle. Advantageously, the foot assembly 100 reduces a likelihood that the ground will be shoveled and moved by improving compaction of the ground, thereby providing a surface against which the foot assembly 100 can stabilize the vehicle 10 or the vehicle 50 during recovery and winching operations.

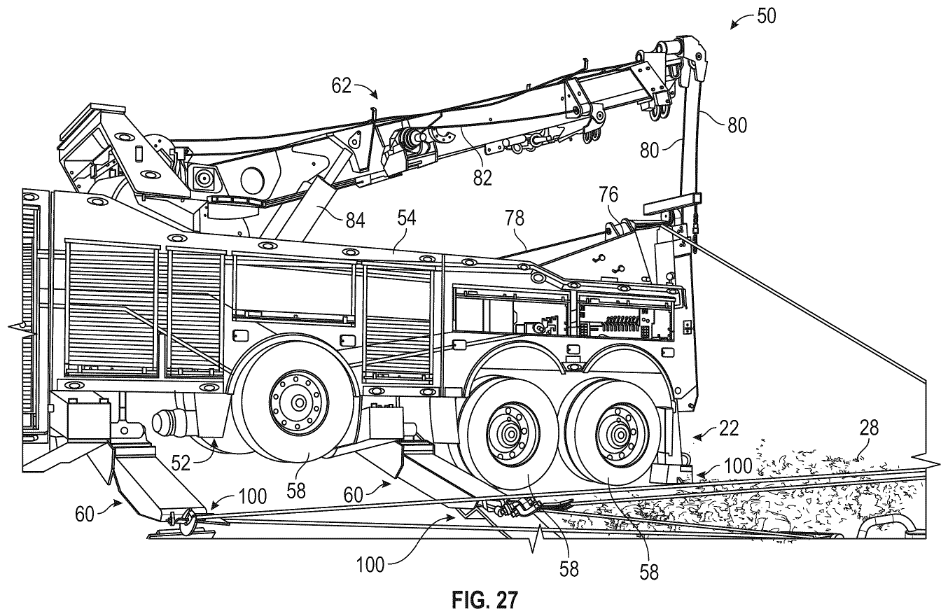

Referring particularly to FIG. 27, the feet assemblies 100 described herein can advantageously provide improved stability by countering loading exerted due to any winches or other loading on the rotator vehicle 50 (or the wrecker vehicle 10). For example, the rotator vehicle 50 can include main boom winch cables 80, main boom auxiliary winch cables 82, and knee boom drag winch cables 78, all of which are driven by winches, and may be a source of loading the feet assemblies 100 in a variety of directions. The feet assemblies 100 advantageously provide improved stability for loading in multiple different directions relative to the rotator vehicle 50 (or the wrecker vehicle 10) individually, or experienced simultaneously.

Referring again to FIGS. 5 and 6-12, the foot assembly 100 includes one or more plates (e.g., plate 102 in the embodiment shown in FIG. 5 or first plate 110 and the second plate 112 in the embodiment shown in FIGS. 6-12) which are removably coupled via pins. The pinned coupling of the one or more plates of the foot assembly 100 can facilitate post recovery cleaning, since the one or more plates can easily be removed and dirt can be cleaned. This may prevent dirt and debris from being stuck in the portion of the foot assembly 100 that folds up for stowage and transport.

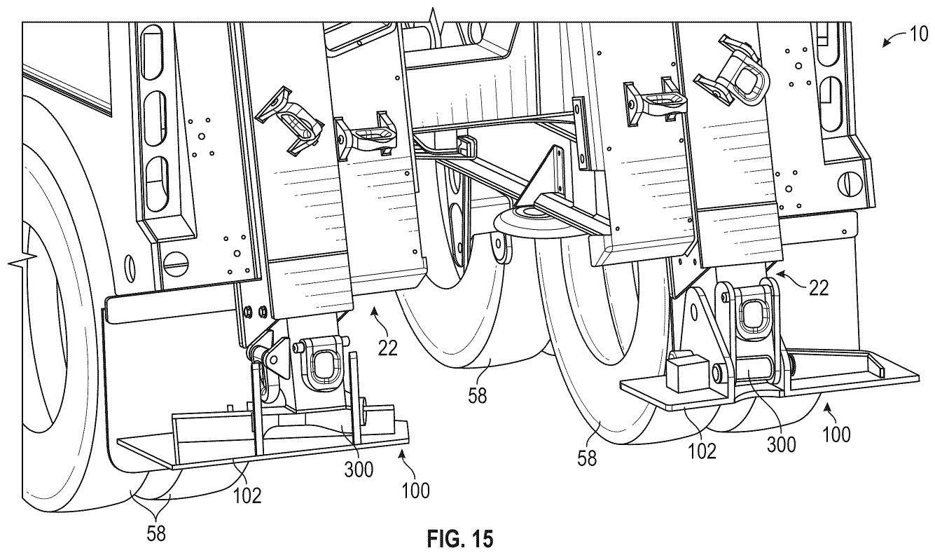

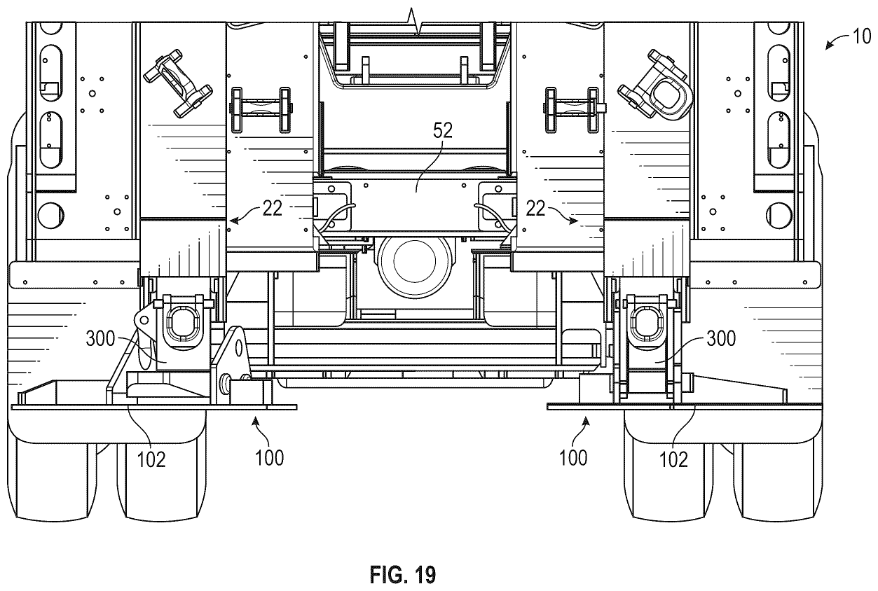

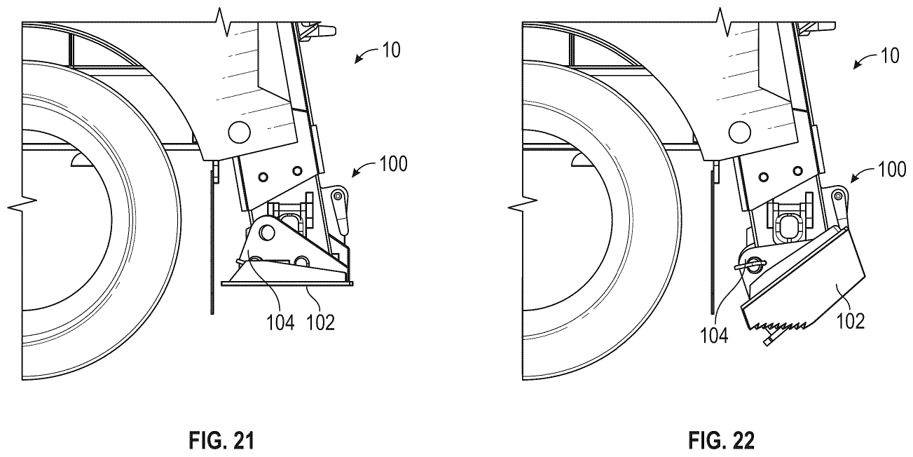

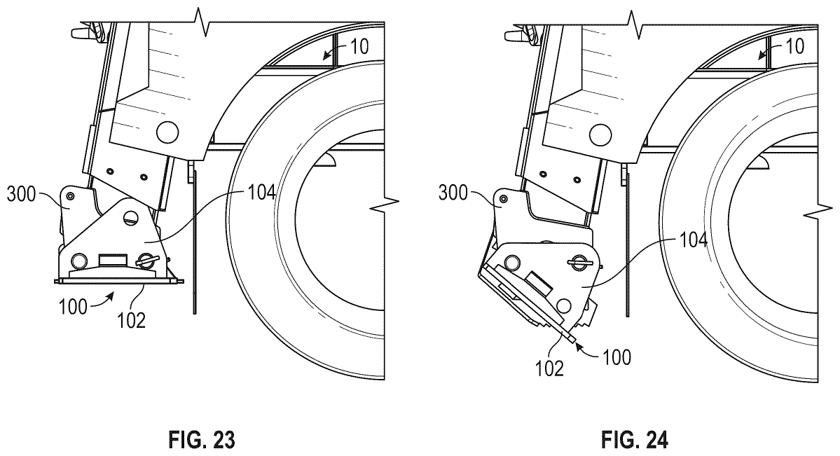

Referring to FIGS. 15-17, 19, 21, and 23 the feet assemblies 100 are shown in a flat orientation. When the feet assemblies 100 are in the flat orientation as shown, the plate 102 is oriented such that the plate is substantially parallel with the ground surface 28. Extending the outrigger assemblies 22 drives the plates 102 into the ground surface in the flat orientation.

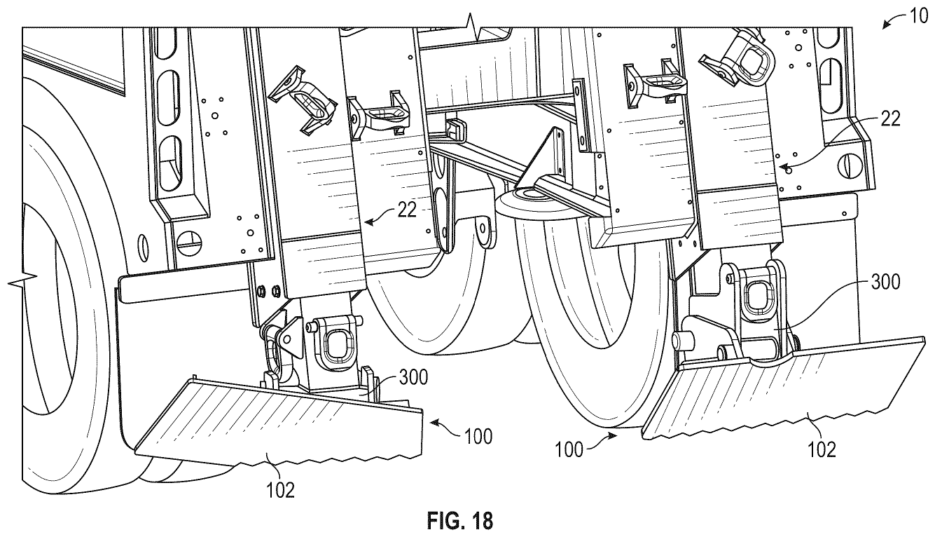

Referring to FIGS. 18, 20, 22, and 24, the feet assemblies 100 are shown both rotated down by 40 degrees. In particular, the feet assemblies 400 are rotated 40 degrees about their respective axes (e.g., the pin that extends through the first opening 107).

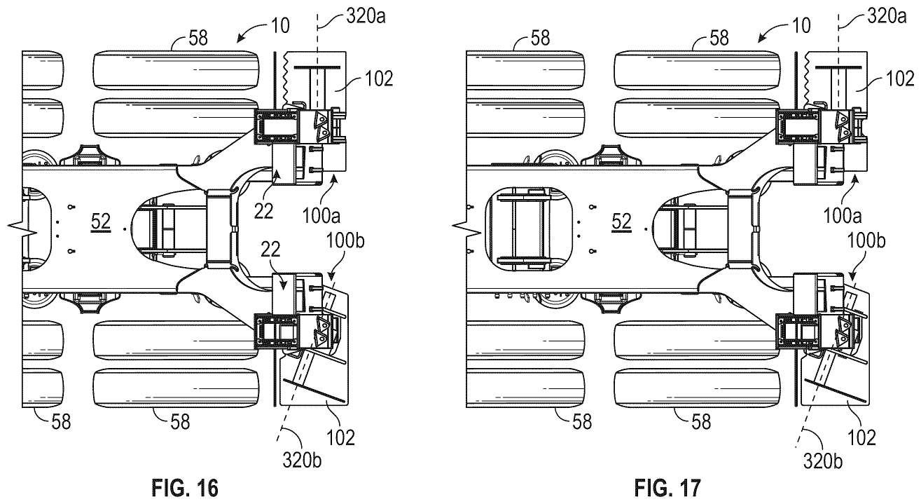

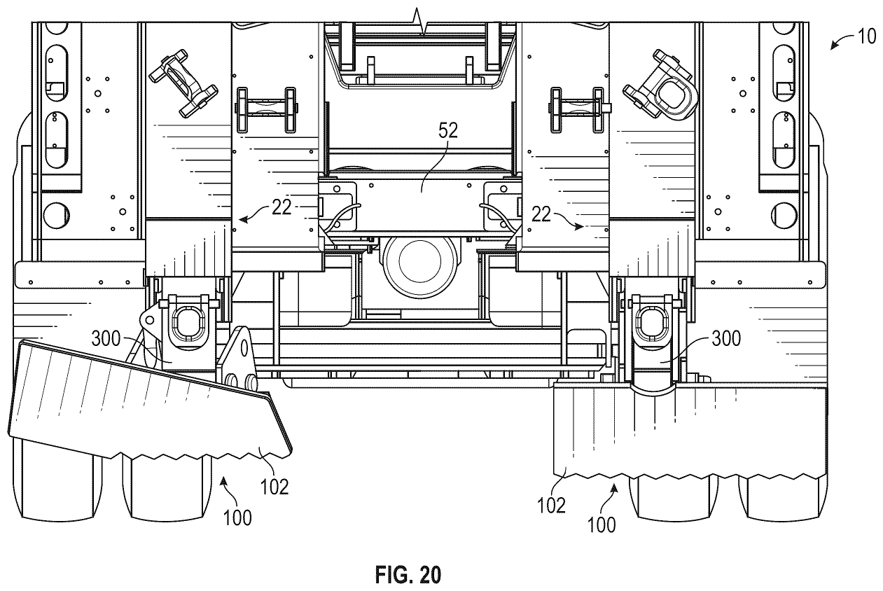

Referring particularly to FIGS. 16 and 17, the feet assemblies 100 are configured to rotate about offset axes 320a and 320b, respectively. In particular, the plate 102 of a first of the feet assemblies, shown as foot assembly 100a, is configured to rotate about a first axis 320a, while the plate 102 of a second of the feet assemblies, shown as foot assembly 100b, is configured to rotate about a second axis 320b. The first axis 320a and the second axis 320b are angularly offset from each other in a plane defined by a longitudinal direction and a lateral direction of the vehicle 10. The first axis 320a may extend in a lateral direction (e.g., a direction parallel with an axis about which the tractive elements 58 rotate). The second axis 320b extends in a partial lateral direction and partially from a rearwards to a forwards of the vehicle 10. In some embodiments, an angle formed between the first axis 320a and the second axis 320b is 20 degrees (e.g., the second axis 320b is offset 20 degrees relative to the first axis 320a). The offset of the second axis 320b relative to the first axis 320a result in different surface areas of the plate 102 that engage the ground surface 28 as shown in FIG. 20. The plate 102 of the foot assembly 100b may have an irregular pentagonal shape.

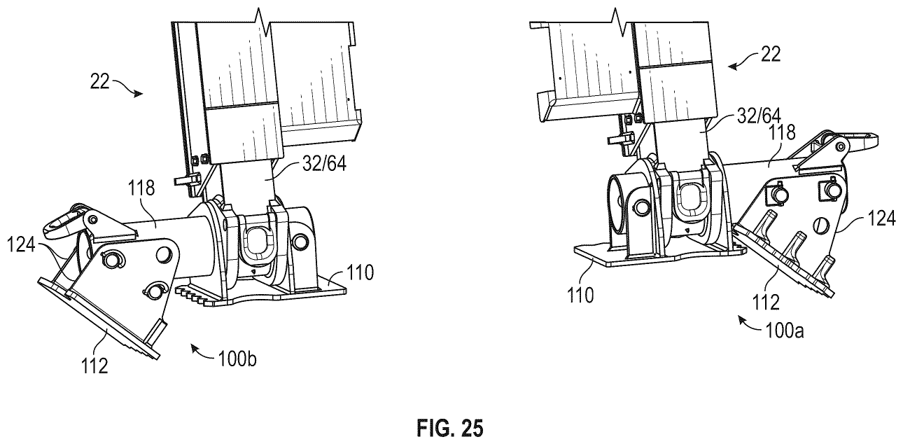

Referring particularly to FIG. 25, the coupling plates 124 and the second plates 112 (e.g., the outboard feet) of a first one of the feet assemblies 100, shown as foot assembly 100a, and of a second of the feet assemblies 100, shown as foot assembly 100b, may be pivoted such that the second plates 112 both face a same direction. In particular, the foot (e.g., the coupling plates 124 and the second plate 112 of the foot assembly 100a) may be removed and re-installed (e.g., by removing the pins as described in greater detail above with reference to FIGS. 6-12) such that the outboard feet are oriented in the same direction (e.g., both facing a curb side or a street side of the vehicle 10). In this way, the outboard feet of the feet assemblies 100 may be pivoted or re-oriented independently about separate axes (e.g., about a second and third axis).

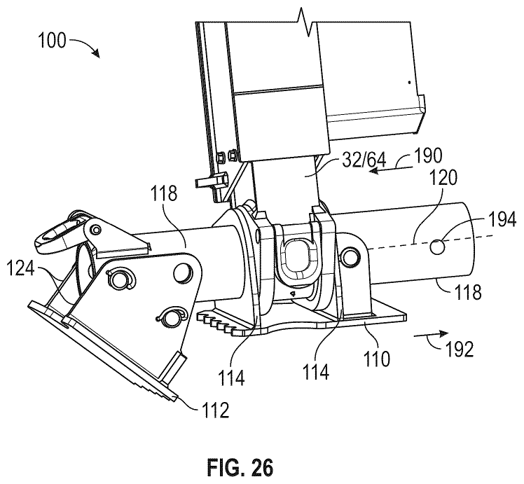

Referring to FIG. 26, the shaft 118 may be elongated and include an opening 194. The shaft 118 may be translatable along the first axis 120 between different predetermined positions (e.g., in a direction 190 or a direction 192). The shaft 118 may be locked in any of the predetermined positions by removing a pin and re-inserting the pin such that the pin extends through a portion of the inner member 32 or the interfacing portion 300 to lock the shaft 118 at the current location. Translation of the shaft 118 relative to the interfacing portion 300 causes movement of the coupling plates 124 and the second plate 112 along the first axis 120 to thereby adjust the position of the second plate 112. Advantageously, providing an extended shaft 118 including different predetermined locations at which the shaft 118 can be pinned facilitates extension of the outboard feet in a lateral direction.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claim.

What is claimed is:

1. A vehicle, comprising:
a frame;
an implement coupled with the frame, the implement configured to be operated to move or lift another vehicle; and
an outrigger assembly fixedly coupled with the vehicle, the outrigger assembly comprising:
a member; and
a foot assembly coupled with an end of the member, the member repositionable to drive the foot assembly into contact with a ground surface, the foot assembly comprising:
a first plate and a second plate defining a plurality of edges configured to engage the ground surface;
wherein the first plate and the second plate are rotatably repositionable in unison about a first axis between a plurality of positions; and
wherein the second plate is, relative to the first plate, rotatably repositionable about a second axis that is perpendicular with the first axis.

2. The vehicle of claim 1, wherein the plurality of edges comprise a toothed pattern configured to facilitate engagement between the plurality of edges and the ground surface.

3. The vehicle of claim 1, wherein the second axis extends radially from the first axis.

4. The vehicle of claim 1, wherein the first axis is defined by a shaft extending through an opening in an end of the member, the first plate coupled with the shaft through a pair of flanges that define an opening through which the shaft extends, the second plate coupled with the shaft through a plurality of pins that extend through openings of a pair of flanges and corresponding openings through the shaft, one of the plurality of pins defining the second axis.

5. The vehicle of claim 4, wherein the second plate is repositionable between a plurality of different positions about the second axis.

6. The vehicle of claim 4, wherein the second plate is repositionable between a plurality of different positions about the second axis, wherein in a first of the plurality of different positions about the second axis, a geometry of an inner edge of the second plate meshes with a geometry of a corresponding inner edge of the first plate.

7. The vehicle of claim 1, wherein the first plate and the second plate are repositionable between a plurality of different positions about the first axis.

8. The vehicle of claim 1, wherein the outrigger assembly extends from a rear of the vehicle or a lateral side of the vehicle.

9. The vehicle of claim 1, wherein the second plate is translatable relative to the first plate along the first axis, the second plate configured to be selectively locked in a plurality of various positions along the first axis.

10. An outrigger assembly for a vehicle, the outrigger assembly comprising:
a member; and
a foot assembly coupled with an end of the member, the member repositionable to drive the foot assembly into contact with a ground surface, the foot assembly comprising:
a first plate and a second plate defining a plurality of edges configured to engage the ground surface;
wherein the first plate and the second plate are rotatably repositionable in unison about a first axis between a plurality of positions; and
wherein the second plate is, relative to the first plate, rotatably repositionable about a second axis that is perpendicular with the first axis.

11. The outrigger assembly of claim 10, wherein the second axis extends radially from the first axis.

12. The outrigger assembly of claim 10, wherein the plurality of edges comprise a toothed pattern configured to facilitate engagement between the plurality of edges and the ground surface.

13. The outrigger assembly of claim 10, wherein the first axis is defined by a shaft extending through an opening in an end of the member, the first plate coupled with the shaft through a pair of flanges that define an opening through which the shaft extends, the second plate coupled with the shaft through a plurality of pins that extend through openings of a pair of flanges and corresponding openings through the shaft, one of the plurality of pins defining the second axis.

14. The outrigger assembly of claim 13, wherein the second plate is repositionable between a plurality of different positions about the second axis.

15. The outrigger assembly of claim 13, wherein the second plate is repositionable between a plurality of different positions about the second axis, wherein in a first of the plurality of different positions about the second axis, a geometry of an inner edge of the second plate meshes with a geometry of a corresponding inner edge of the first plate.

16. The outrigger assembly of claim 10, wherein the first plate and the second plate are repositionable between a plurality of different positions about the first axis.

17. The outrigger assembly of claim 10, wherein the second plate is translatable relative to the first plate along the first axis, the second plate configured to be selectively locked in a plurality of various positions along the first axis.

18. A foot assembly for an outrigger of a vehicle, the foot assembly comprising:
a shaft; and
a first plate and a second plate defining a plurality of edges configured to engage a ground surface, the first plate coupled with the shaft through a pair of flanges that define an opening through which the shaft extends, the second plate coupled with the shaft through a plurality of pins that extend through openings of a pair of flanges and corresponding openings through the shaft, one of the plurality of pins defining a second axis;
wherein the first plate and the second plate are rotatably repositionable in unison about a first axis between a plurality of positions; and
wherein the second plate is, relative to the first plate, rotatably repositionable about the second axis that is perpendicular with the first axis.

19. The foot assembly of claim 18, wherein the second plate is repositionable between a plurality of different positions about the second axis, wherein in a first of the plurality of different positions about the second axis, a geometry of an inner edge of the second plate meshes with a geometry of a corresponding inner edge of the first plate.

20. The foot assembly of claim 18, wherein the second plate is translatable relative to the first plate along the first axis by movement of the shaft, the second plate configured to be selectively locked in a plurality of various positions along the first axis.
